(19) United States
(12) Patent Application Publication
(10) Pub. No.: US 2017/0357681 A1
(43) Pub. Date: Dec. 14, 2017

(54) DYNAMIC IN-FLIGHT DATABASE REQUEST THROTTLING

(71) Applicant: Teradata US, Inc., Dayton, OH (US)

(72) Inventors: Douglas P. Brown, Rancho Santa Fe, CA (US); Thomas Julien, San Marcos, CA (US); Frank Roderic Vandervort, Ramona, CA (US)

(21) Appl. No.: 15/386,053

(22) Filed: Dec. 21, 2016

Related U.S. Application Data
(60) Provisional application No. 62/272,221, filed on Dec. 29, 2015.

(51) Int. Cl. G06F 17/30; G06F 17/18; G06F 9/38; G06F 9/455

(52) U.S. Cl. CPC G06F 17/30348; G06F 9/3855; G06F 17/18; G06F 17/30371; G06F 2009/45583

(57) ABSTRACT

Various embodiments herein each include at least one of systems, methods and software for dynamic in-flight database request throttling. One such embodiment includes monitoring a database or multi-database system Workload Definition (WD) to identify queuing of a higher priority request while the database system is processing requests of a lower priority and when queuing of a higher priority request is identified, adjusting a metric throttle for the WD to a new metric throttle level Cₙ, computed as the average of a metric level C_{c} that would drive the metric to a target T and a metric level Cᵣ that would drive a rolling average of the metric to the target T. This embodiment further includes evaluating lower priority in-flight requests for the current workload to identify abort candidate requests to abort and aborting the identified abort candidate requests and place the aborted requests in a delay queue for later execution. Some embodiments of this method also include, when the metric T has not yet been met, identifying lower priority in-flight requests of the current workload to identify suspend candidate requests and suspending the identified suspend candidate requests and place the suspended requests in a suspend queue to complete execution later.

### PRIORITY APPLICATIONS

This application claims the benefit of U.S. Provisional Patent Application Ser. No. 62/272,221, filed Dec. 29, 2015, the content of which is hereby incorporated by reference in its entirety.

### BACKGROUND INFORMATION

Data can be an abstract term. In the context of computing environments and systems, data can generally encompass all forms of information storable in a computer readable medium (e.g., memory, hard disk). Data, and in particular, one or more instances of data can also be referred to as data object(s). As is generally known in the art, a data object can, for example, be an actual instance of data, a class, a type, or a particular form of data, and so on.

Data can be an abstract term. In the context of computing environments and systems, data can generally encompass all forms of information storable in a computer readable medium (e.g., memory, hard disk). Data, and in particular, one or more instances of data can also be referred to as data object(s). As is generally known in the art, a data object can, for example, be an actual instance of data, a class, a type, or a particular form of data, and so on.

Generally, one important aspect of computing and computing systems is storage of data. Today, there is an ever increasing need to manage storage of data in computing environments. Databases are good examples of computing environments or systems where the storage of data can be crucial. As such, databases are discussed below in greater detail as an example.

The term database can also refer to a collection of data and/or data structures typically stored in a digital form. Data can be stored in a database for various reasons and to serve various entities or “users.” Generally, data stored in the database can be used by one or more of the “database users.” A user of a database can, for example, be a person, a database administrator, a computer application designed to interact with a database, etc. A very simple database or database system can, for example, be provided on a Personal Computer (PC) by storing data (e.g., contact information) on a Hard Disk and executing a computer program that allows access to the data. The executable computer program can be referred to as a database program, or a database management program or database management system. The executable computer program can, for example, retrieve and display data (e.g., a list of names with their phone numbers) based on a request submitted by a person (e.g., show me the phone numbers of all my friends in Ohio).

Generally, database systems are much more complex than the example noted above. In addition, databases have been evolved over the years and are used in various business and organizations (e.g., banks, retail stores, governmental agencies, universities). Today, databases can be very complex. Some databases can support several users simultaneously and allow them to make very complex queries (e.g., give me the names of all customers under the age of thirty-five (35) in Ohio that have bought all the items in a given list of items in the past month and also have bought a ticket for a baseball game and purchased a baseball hat in the past 10 years).

Typically, a Database Manager (DBM) or a Database Management System (DBMS) is provided for relatively large and/or complex databases. As known in the art, a DBMS can effectively manage the database or data stored in a database, and serve as an interface for the users of the database. For example, a DBMS can be provided as an executable computer program (or software) product as is also known in the art.

It should also be noted that a database can be organized in accordance with a Data Model. Some notable Data Models include a Relational Model, an Entity-relationship model, and an Object Model. The design and maintenance of a complex database can require highly specialized knowledge and skills by database application programmers, DBMS developers/programmers, database administrators (DBAs), etc. To assist in design and maintenance of a complex database, various tools can be provided, either as part of the DBMS or as free-standing (stand-alone) software products. These tools can include specialized Database languages (e.g., Data Description Languages, Data Manipulation Languages, Query Languages). Database languages can be specific to one data model or to one DBMS type. One widely supported language is Structured Query Language (SQL) developed, by in large, for Relational Model and can combine the roles of Data Description Language, Data Manipulation Language, and a Query Language.

Today, databases have become prevalent in virtually all aspects of business and personal life. Moreover, usage of various forms of databases is likely to continue to grow even more rapidly and widely across all aspects of commerce, social and personal activities. Generally, databases and DBMS that manage them can be very large and extremely complex partly in order to support an ever increasing need to store data and analyze data. Typically, larger databases are used by larger organizations, larger user communities, or device populations. Larger databases can be supported by relatively larger capacities, including computing capacity (e.g., processor and memory) to allow them to perform many tasks and/or complex tasks effectively at the same time (or in parallel). On the other hand, smaller database systems are also available today and can be used by smaller organizations. In contrast to larger databases, smaller databases can operate with less capacity.

A current popular type of database is the relational database with a Relational Database Management System (RDBMS), which can include relational tables (also referred to as relations) made up of rows and columns (also referred to as tuples and attributes). In a relational database, each row represents an occurrence of an entity defined by a table, with an entity, for example, being a person, place, thing, or another object about which the table includes information.

One important objective of databases, and in particular a DBMS, is to optimize the performance of queries for access and manipulation of data stored in the database. Given a target environment, an “optimal” query plan can be selected as the best option by a database optimizer (or optimizer). Ideally, an optimal query plan is a plan with the lowest cost (e.g., lowest response time, lowest CPU and/or I/O processing cost, lowest network processing cost). The response time can be the amount of time it takes to complete the execution of a database operation, including a database request (e.g., a database query) in a given system. In this context, a “workload” can be a set of requests, which may include queries or utilities, such as, load that have some common characteristics, such as, for example, application, source of request, type of query, priority, response time goals, etc.

Generally, data (or “Statistics”) can be collected and maintained for a database. “Statistics” can be useful for various purposes and for various operational aspects of a database. In particular, “Statistics” regarding a database can be very useful in optimization of the queries of the database, as generally known in the art.

More recently, in-memory processing systems, including in-memory database systems have been developed where data is typically stored and processed in memory which can offer much faster processing times than systems that also store data for processing in non-volatile or persistent storages (e.g., Hard Disk Drives (HDD's, Solid Disk Drives (SOD), Flash memory).

Database systems and environments are useful.

### SUMMARY

Various embodiments herein each include at least one of systems, methods and software for dynamic in-flight database request throttling. One such embodiment includes monitoring a database system or multi-database systems Workload Definition (WD) to identify queuing of a higher priority request while the database system(s) are processing requests of a lower priority and when queuing of a higher priority request is identified, adjusting a metric throttle for the WD to a new metric throttle level Cₙ, computed as the average of a theoretical metric level C_{c} that would drive the metric to a target T and a theoretical metric level Cᵣ that would drive a rolling average of the metric to the target T. This embodiment further includes evaluating lower priority in-flight requests for the current workload to identify abort candidate requests to abort and aborting the identified abort candidate requests and place the aborted requests in a delay queue for later execution. Some embodiments of this method also include, when the metric T has not yet been met, identifying lower priority in-flight requests of the current workload to identify suspend candidate requests and suspending the identified suspend candidate requests and place the suspended requests in a suspend queue to complete execution later.

### BRIEF DESCRIPTION OF THE DRAWINGS

FIG. 1 shows the effect of managing with a rolling average.

FIG. 2 shows a comparison between a current metric and a rolling average of the metric.

FIG. 3 is a flow chart.

FIG. 4 is a flow chart.

### DETAILED DESCRIPTION

As noted in the background section, database systems and environments are useful.

Currently, database management systems can monitor and effectively control processing of database queries. For example, Teradata Work Management (TDWM) “Traffic Cop” can let a user choose an event type for a Workload Definition (WD) defined in a RuleSet. This is commonly referred to as a: “By-WD” event. Today, these events can be used primarily for monitoring and reporting purposes, to gauge the success of the workload's performance, and to note trends with respect to meeting SLGs.

A second use of the By-WD events is to automatically detect when Arrival and Concurrency levels are too high or conversely too low. For example, one of the primary approaches used by DBAs and System Administrators is to first identify that there is a problem with their system. Investigations into why will typically start with analysis at the system-level (System CPU). If the system is not 100% busy and does not have heavy skewing, then typically the DBA can next check for:
a) if Arrival Rate>Throughput System Level Goals (SLG), then a possible cause of the missed SLG is System Over-load. Not only is the system falling behind and unable to keep up with arrivals to this workload, other competing workloads may be impacting the ability to at least deliver the throughput SLG;
b) if Arrival Rate<=Throughput SLG, then the cause of the missed SLG is under-demand. In other words, there is insufficient demand from the application servers to meet the throughput SLG. The system could be nearly idle and still miss the throughput SLG, so by pre-qualifying the missed SLG throughput event with arrivals>throughput SLG, you avoid detecting an uninteresting situation.

However, if the CPU is 100% busy, then the number of active sessions will be checked for unusually high levels of concurrency. Concurrency can be defined based on the concurrent requests or queries (e.g., two (2) concurrent SQL queries running at the same time).

Generally, these investigations are typically triggered based on the By-WD event enabling the DBA to act manually or automatically to resolve the situation, and bring WD performance back to SLG conformance. To automate correction for these type problems currently requires what is called a “state change”. A state change is a relatively expensive operation. Performing a state change in the middle of a system undergoing workload management performance issues can have latency issues to take affect due to the expense of the state change operation. It should be noted that customers cannot define ‘states’ for all scenarios without creating a large and complex State Matrix, i.e., a predefined set of Teradata Active System Management (TASM) rules for varied conditions. Some customers go to the trouble to dynamically create rule sets that adjust the throttle when a performance crisis occurs. There is a need for dynamic methods to adjust throttles without a ‘State Change’. In other words, “Dynamic throttles” are needed.

Dynamic throttles as defined today provide a mechanism to put limits on the number of new requests, such as SQL requests, by workload classification. Such limits can be dynamically adjusted by the system based upon an assessment of the system's ability to take on new work based upon an historical rolling average of resource availability and estimates of resource requirements for the type of requests the throttles apply. The throttles provide a mechanism to prevent new work from entering the system if that new work would over utilize the system resources (CPU, memory, AWTs, etc.) and thus cause performance degradation and missed SLAs.

In one aspect, a method for implementing Dynamic Throttles is provided. The methods can, for example, be provided as a light-weight method for implementing Dynamic throttles that can solve problems associated conventional techniques with relatively less overhead. In doing so, a type of dynamic throttle (concurrency) event can be defined to assist the customers in managing complex workload management by environments, automatically changing the value of a throttle as an event. A new type of event (throttle event) that can automatically act within the framework of the TDWM regulator but does not require a State change.

It should be noted that the technique can also be applied to unusually high numbers of AMP Worker Task (AWT) activity. If some workloads have too many active sessions, then appropriate actions can be taken, for example, to limit concurrency (with a throttle), to abort or suspend queries, and/or to make adjustments to the Priority Scheduler weights. If the CPU is 100% busy and active sessions looks ok, the DBA might next check the CPU usage by WD and/or Session to see if there is a runaway query. From here the DBA can take the appropriate action, usually to abort or suspend the offending request or move it to a Penalty-box with a CPU limit or cap.

Often the business' ultimate management goal is to manage a workload's concurrency on an hourly or daily basis, without concern for momentary low or high-usage. As such, the customers desire the opportunity to make up for low-usage moments by over-consuming for a time. Those low-usage moments can be due to either low Timeshare issues, or under-demand. Therefore, a new option is created for Timeshare only WDs.

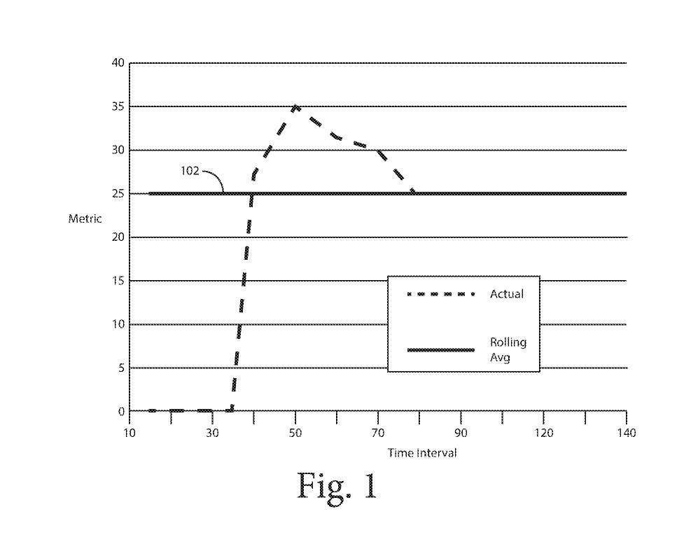

By-WD events allow the DBA to manage based on a Rolling Averaging 102 whose duration is of the DBA's choosing, as shown in FIG. 1. TDWM would manage the rolling average 102 and derive the resultant “Dynamic throttle” value for the moment via control theory and other Statistical processing techniques (SPC). It would then communicate a revised concurrency value to TDWM for its management at appropriate intervals.

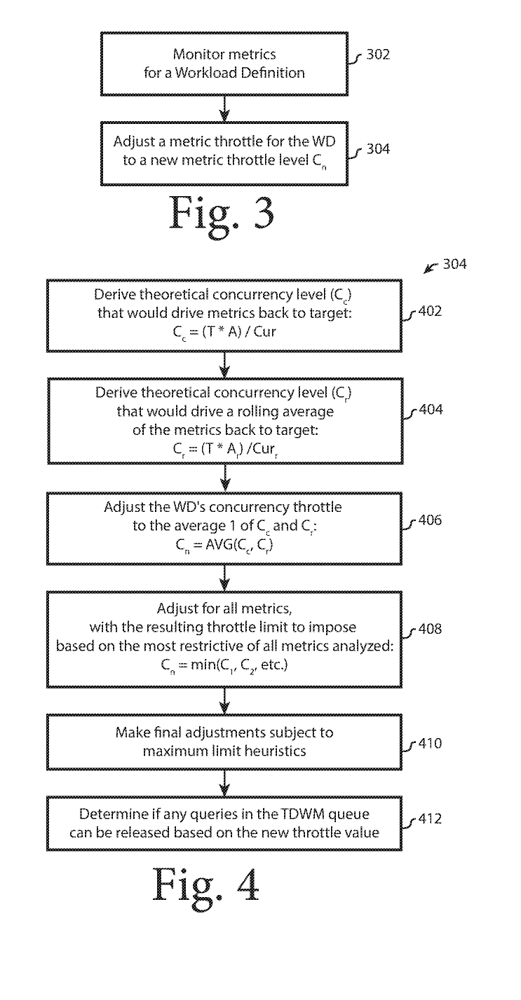

TDWM can, for example, monitor key health and demand metrics (By-WD events) (block 302) to determine what the timeshare WD throttle limit should be at any given point in time (block 304), as shown in FIG. 3. The limit can change dynamically and constantly, just as the system demand and health characteristics also change constantly due to normal mixed workload variations. By monitoring these metrics and then adjusting the throttle limit based on those metrics, the key health and demand resources can be indirectly monitored to stay within healthy levels, thereby maintaining the system in a healthier state.

The monitoring of key metrics and subsequent throttle limit adjustment can rely on control theory and Statistical processing techniques to reduce oscillation in the regulation (“cruise-control”). The control theory technique used to accomplish this is to base adjustments on both the current actual metric values as well as the historical metric values. A technique for dynamic automatic throttles can include the following:
Target Value (T) for each monitored metric. (Concurrency, AWTs, CPU, I/O, Memory, Service Time delays, etc.)
Data obtained from monitoring the By-WD events is done internally within the TDWM regulator:
   Current metric value (Cur)
   Current Timeshare Automatic Throttle Limit (C_{c})
   Current Timeshare Concurrency Level (A) (for “active” concurrent queries
   RollingAvg Timeshare Concurrency (Aᵣ)
   RollingAvg metric value (Curᵣ)

Some embodiments include performing the following analysis and concurrency throttle adjustment at every Traffic Cop event interval, as shown in FIG. 4.

(For example, every 60, 600, 3600 seconds, etc.)
Derive theoretical concurrency level (C_{c}) that would drive metrics back to target (block 402):

C_{c}=(T*A)/Cur
Derive theoretical concurrency level (Cᵣ) that would drive Rolling Average of the Concurrency back to target (block 402):

Cᵣ=(T*Aᵣ)/Curᵣ
Adjust the WD's concurrency throttle to the average 1 of C_{c} and Cᵣ (block 406):

Cₙ=AVG(C_{c},Cᵣ)
Adjust for all metrics, with the resulting throttle limit to impose based on the most restrictive of all metrics analyzed (block 408):

Cₙ=min(C₁,C₂,etc.)
Final adjustments: subject to maximum limit heuristics—For example, Timeshare limit cannot exceed X % of total AWT pool (block 410).
Determine if any queries in the TDWM queue can be released based on the new throttle value (block 412). If so dynamically change the throttle value and release the queries from the TDWM queue.

Min keeps the metric below the threshold. Average would allow over-consumption to compensate for under-consumption, which is useful for concurrency management.

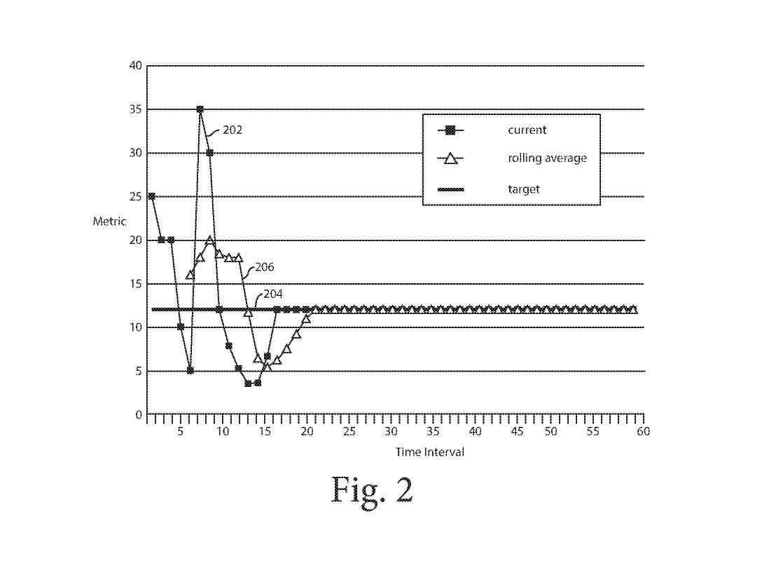

FIG. 2 shows an environment that was allowed to run with no concurrency throttle values established for a small period of time. Here you can see the wild swings in the current metric (concurrency) levels 202. In this example a Target (T) concurrency value 204 was established by using a Rolling average of 3600 seconds. In this particular case you can see a Target (T) throttle value of 12 was derived. The current concurrency 202 and rolling average metrics 206 is measured as a By-WD event with a timer set at 60 seconds. The task of the dynamic concurrency throttle algorithm is to bring the environment's concurrency health metrics back to target. FIG. 2 shows the result of the algorithm described above in bringing the concurrency back in line with the target. It is important to note that a goal of some embodiments is to bring the current metrics back to conformity and then keep it there. FIG. 2 demonstrates this algorithm's ability to do this effectively. Note that because actual active concurrency is part of the formula, it doesn't necessarily adjust a limit up when there is no demand.

This approach can simplify the implementation of dynamic throttles as well as removing the dependency of a State change at the cost of user complexity.

However, one issue with this approach is that in-flight, or in process, requests are not dynamically suspended or aborted. Thus, if a rush of higher priority work arrives that should take precedent over the current work being processed and causes a dynamic throttle to allow less concurrency on a particular workload, that workload's concurrency limit will be exceeded until enough in-flight requests complete to drop the currency level down to its new concurrency limit. This allows that workload to consume resources that could, and likely should, be available to the newly requested higher priority work. The net effect of this scenario is that although the system will eventually reach a dynamically changed throttle limit, the system is slower than ideal in reacting to a dynamic throttle limit change to reduce concurrency.

Thus, dynamic throttles in some embodiments take into consideration in-flight requests in addition to new incoming requests. Two possible actions or methods can be used for reducing the concurrency until the workload throttle concurrency level is met. One method is to ‘silently’ abort a request and place a new instance of it on the workload management delay queue to be run later. This method to abort a request and restart it from the first execution step is called the Abort method. The second method is to ‘suspend’ a request at a quiet point following completion of a unit of work of the request and place it on the delay queue to be resumed later. This method is called the Suspend method. Requests placed on the delay queue using either the Abort or Suspend method would be released from the delay queue using the existing TASM methodology for releasing a request. In this case, it would be either when the concurrency level for requests in that workload drops below the new level set by the dynamic throttle, or when the dynamic throttle loosens the concurrency limit allowing more concurrency. Note that in some embodiments, when requests are released, requests that have been suspended are released prior to requests that have been aborted.

The Abort method has the advantage of reaching the concurrency level quicker, at a cost of re-executing the completed portion of work. The Suspend method has the opposite effect, that is, no work is lost, but when compared to the Abort method there will still be some delay (in order to complete the in-flight step and to cache data representative of the work in progress and the suspended state of the request) before a request can be suspended. Additionally, requests put on the delay queue through the Abort method hold no locks or spool resources. Requests delayed using the Suspend method may continue to hold locks and have intermediate results that must be retained. To avoid potential blocking issues, some embodiments include an option that limits Suspend method candidate requests to a specific lock severity level (e.g., only request using Access locks be considered).

Upon adjusting the dynamic throttle limit lower for a given workload in order to reduce concurrency, TASM would first evaluate in-flight requests for that workload to identify Abort Method candidates. The first step in some embodiments is to identify requests for the Abort and take action of those requests. After processing the Abort Method candidates, if additional adjustments are needed, TASM would next evaluate in-flight requests for that workload to identify Suspend Method candidates, and then take action on those requests.

Requests may be chosen as Abort method candidates when their estimated progress (based on the last completed step) is less than a ‘percentage complete’ setting. The ‘percentage complete’ value may be user configurable and default to a system-provided value (for example, 10° %). Different dynamic throttles could have different ‘percentage complete’ settings. Note this user configurable setting allows a user the flexibility so that either only the Abort method is used or that only the Suspend method is used. That is, a user configurable setting of 0% would indicate no requests would use the Abort method, and a user configurable setting of 100% would indicate all requests would use the Abort method.

In the Abort method phase, if reducing workload's concurrency by the number of candidates does not bring the concurrency to the desired value or brings it exactly to the desired value, then all candidates would be silently aborted by TASM and placed back onto the delay queue to be executed from the first execution step using normal TASM delay queue request release algorithms, as is done today when a request is put on the delay queue. If reducing a workload's concurrency by the number of candidates would bring the concurrency below the desired value, then only a subset of those candidates needs to be chosen and the Abort method applied. There are various methods for choosing the order to select the subset of candidates to Abort. For example, they may be chosen by applying a Last-In-First-Out (LIFO) algorithm, the requests which had the least estimated percentage complete, based on a determined processing cost of the various requests and a fitting algorithm that selects a combination of the requests with a sum cost that will achieve a desired concurrency level, among other possible algorithms.

In some embodiments, when the Abort method was successful in reaching the desired concurrency level, then the Suspend method would not be used.

In some embodiments, after completing the Abort method phase, when the desired concurrency level for the dynamic throttle was not reached, TASM would next identify requests for the Suspend method. N requests are identified for suspension, where N is the number of requests needed to meet the desired concurrency level for the workload after the Abort method phase completes. As with identifying candidate requests to be aborted, there are also various methods that may be utilized for identifying requests to be suspended. Once identified, the requests would continue normally until the completion of the step currently in progress. Requests are typically broken into a number of steps for execution by a request optimizer. These steps are generally units of work to be completed in performance of the request. Thus, when a current unit of work completes, the request is then suspended and the next unit of work is not yet performed, data work-in-progress and status of the request is cached and moved to the TASM delay queue. In some embodiments, when an in-flight request in the dynamic workload completes during the time that TASM is waiting for candidate requests to Suspend, TASM will remove a request from the Suspend candidate list instead of releasing a request from delay queue. This is done until there are no more Suspend candidates.

When releasing requests from the delay queue, TASM would release ‘suspended’ requests prior to starting any new requests. Aborted requests are the next priority, ahead of other requests delayed normally, i.e., where request execution had never started.

Such embodiments provide dynamic throttling benefit more by quickly adjusting the system to adhere to the dynamic throttle changes, which more quickly allocates system resources to higher priority work upon its arrival.

Generally, various aspects, features, embodiments or implementations of the invention described above can be used alone or in various combinations. Furthermore, implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile or near-tactile input.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
monitoring at least one database system Workload Definition (WD) to identify queuing of a higher priority request while the at least one database system is processing requests of a lower priority;
when queuing of a higher priority request is identified, adjusting a metric throttle for the WD to a new metric throttle level Cₙ;
evaluating lower priority in-flight requests for the current workload to identify abort candidate requests to abort;
aborting the identified abort candidate requests.

2. The method of claim 1, further comprising:
placing the aborted requests in a delay queue for later execution.

3. The method of claim 2, further comprising:
when the metric T has not yet been met, identifying lower priority in-flight requests of the current workload to identify suspend candidate requests; and
suspending the identified suspend candidate requests; and
placing the suspended requests in a suspend queue to complete execution later.

4. The method of claim 1, wherein the new metric throttle level Cₙ is computed as the average of a metric level C_{c} that would drive the metric to a target T and a metric level Cᵣ that would drive a rolling average of the metric to the target T.

5. The method of claim 4, wherein the metric levels C_{c} and Cᵣ are theoretical metric levels.

6. The method of claim 1, wherein the at least one database system is a multi-database system.

7. A non-transitory computer readable storage medium with instructions stored thereon which when executed by a computer processor cause the computer to perform data processing activities comprising:
monitoring at least one database system Workload Definition (WD) to identify queuing of a higher priority request while the at least one database system is processing requests of a lower priority;
when queuing of a higher priority request is identified, adjusting a metric throttle for the WD to a new metric throttle level Cₙ;
evaluating lower priority in-flight requests for the current workload to identify abort candidate requests to abort;
aborting the identified abort candidate requests.

8. The non-transitory computer readable storage medium of claim 7, the data processing activities further comprising:
placing the aborted requests in a delay queue for later execution.

9. The non-transitory computer readable storage medium of claim 8, the data processing activities further comprising:
when the metric T has not yet been met, identifying lower priority in-flight requests of the current workload to identify suspend candidate requests; and
suspending the identified suspend candidate requests, and
placing the suspended requests in a suspend queue to complete execution later.

10. The non-transitory computer readable storage medium of claim 7, wherein the new metric throttle level Cₙ is computed as the average of a metric level C_{c} that would drive the metric to a target T and a metric level Cᵣ that would drive a rolling average of the metric to the target T.

11. The non-transitory computer readable storage medium of claim 10, wherein the metric levels C_{c} and Cᵣ are theoretical metric levels.

12. The non-transitory computer readable storage medium of claim 7, wherein the at least one database system is a multi-database system.

13. A system comprising:
at least one computer processor, at least one network interface device, and at least one memory device;
instructions stored on the at least one memory device that are executable by the at least one computer process to perform data processing activities comprising:
monitoring at least one database system Workload Definition (WD) to identify queuing of a higher priority request while the at least one database system is processing requests of a lower priority;
when queuing of a higher priority request is identified, adjusting a metric throttle for the WD to a new metric throttle level Cₙ;
evaluating lower priority in-flight requests for the current workload to identify abort candidate requests to abort;
aborting the identified abort candidate requests.

14. The system of claim 13, the data processing activities further comprising:
placing the aborted requests in a delay queue for later execution.

15. The system of claim 14, the data processing activities further comprising:
when the metric T has not yet been met, identifying lower priority in-flight requests of the current workload to identify suspend candidate requests; and
suspending the identified suspend candidate requests; and
placing the suspended requests in a suspend queue to complete execution later.

16. The system of claim 13, wherein the new metric throttle level Cₙ is computed as the average of a metric level C_{c} that would drive the metric to a target T and a metric level Cᵣ that would drive a rolling average of the metric to the target T.

17. The system of claim 16, wherein the metric levels C_{c} and Cᵣ are theoretical metric levels.

18. The system of claim 13, wherein the at least one database system is a multi-database system.
